(19) United States
(12) Patent Application Publication
(10) Pub. No.: US 2004/0241309 A1
(43) Pub. Date: Dec. 2, 2004

(54) Food-grade-lubricant

(75) Inventor: William W. Garmier, Hartville, OH (US)

Correspondence Address: Daniel A. Thomson, Brouse McDowell, LPA, Ste. 500, 106 S. Main Street, Akron, OH, 44308-1471, US

(73) Assignee: RENEWABLE LUBRICANTS.

(21) Appl. No.: 10/854,843

(22) Filed: May 27, 2004

Related U.S. Application Data
(60) Provisional application No. 60/474,572, filed on May 30, 2003.

(51) Int. Cl. A23L 1/05

(52) U.S. Cl. 426/601

(57) ABSTRACT

The present invention discloses an improved food-grade-lubricant useful as hydraulic oil, circulating oil, drip oil, general purpose oil, grease base oil, cable oil, chain oil, spindle oil, gear oil, and compressor oil for equipment in the food service industry. The lubricant comprises at least one vegetable oil, at least one polyalphaolefin, and at least one antioxidant. The lubricant has improved properties when subjected to thermal and mechanical stress.

This application claims priority to a provisional patent application Ser. No. 60/474,572, titled “Food-grade-Lubricant having FDA approved additives,” filed May 30, 2003.

### FIELD OF THE INVENTION

The invention relates to an improved food-grade-lubricant useful as hydraulic oil, circulating oil, drip oil, general purpose oil, grease base oil, cable oil, chain oil, spindle oil, gear oil, and compressor oil for equipment in the food service industry. Specifically, it relates to a composition comprising at least one vegetable oil, at least one polyalphaolefin (PAO), and at least one antioxidant. More specifically, it relates to a food-grade-lubricant composition having enhanced properties when subjected to thermal and mechanical stress.

### BACKGROUND OF THE INVENTION

The equipment used in the food processing industry varies by segment with the leading segments comprising meat and poultry, beverages, snack foods, vegetables, and dairy. While the equipment varies from segment to segment, the moving parts such as bearings, gears, and slide mechanisms are similar and often require lubrication. The lubricants most often used include hydraulic, refrigeration, and gear oils, as well as all-purpose greases. These food industry oils must meet more stringent standards than other industry lubricants.

Due to the importance of ensuring and maintaining safeguards and standards of quality for food products, the food industry must comply with the rules and regulations set forth by the United States Department of Agriculture (USDA). The Food Safety Inspection Service (FSIS) of the USDA is responsible for all programs involving the inspection, grading, and standardization of meat, poultry, eggs, dairy products, fruits, and vegetables. These programs are mandatory, and inspection of non-food compounds used in federally inspected plants is required.

The FSIS is custodian of the official list of authorized compounds for use in federally inspected plants. The official list (see page 11-1, List of Proprietary Substances and Non-food Compounds, Miscellaneous Publication Number 1419 (1989) by the Food Safety and Inspection Service, United States Department of Agriculture) states that lubricants and other substances that are susceptible to incidental food contact are considered indirect food additives under USDA regulations. Therefore, these lubricants, classified as either H-1 or H-2, are required to be approved by the USDA before being used in food processing plants. The most stringent classification, H-1, is for lubricants approved for incidental food contact. The H-2 classification, is for uses where there is no possibility of food contact, assures that no known poisons or carcinogens are used in the lubricant. One embodiment of the present invention pertains to an H-1 approved lubricating oil. The terms “H-1 approved oil” and “food grade” will be used interchangeably for the purpose of this application.

(Although the USDA is no longer approving new ingredients and compositions, the H-1 classification is still recognized by the world food industry. NSF is now listing and approving the food grade classification.)

In addition to meeting the requirements for safety set by federal regulatory agencies, the product must be an effective lubricant. Lubricating oils for food processing plants should lubricate machine parts, resist viscosity change, resist oxidation, protect against rusting and corrosion, provide wear protection, prevent foaming and resist the formation of sludge while in service. The product should also perform effectively at various lubrication regimes ranging from hydrodynamic thick film regimes to boundary thin film regimes.

The oxidation, thermal, and hydrolytic stability characteristics of a lubricating oil help predict how effectively an oil will maintain its lubricating properties over time and resist sludge formation. Hydrocarbon oils are partially oxidized when contacted with oxygen at elevated temperatures for prolonged periods of time. The oxidation process produces acidic bodies within the lubricating oil. These acidic bodies are corrosive to metals often present in food processing equipment, and, when in contact with both the oil and the air, are effective oxidation catalysts that further increase the rate of oxidation. Oxidation products contribute to the formation of sludges that can clog valves, plug filters, and result in overall breakdown of the viscosity characteristics of the lubricant. Under some circumstances, sludge formation can result in pluggage, complete loss of oil system flow, and failure or damage to machinery.

The thermal and hydrolytic stability characteristics of lubricating oil reflect primarily on the stability of the lubricating oil additive package. The stability criteria monitor sludge formation, viscosity change, acidity change, and the corrosion tendencies of the oil. Hydrolytic stability assesses these characteristics in the presence of water. Inferior stability characteristics result in lubricating oil that loses lubricating properties over time and precipitates sludge.

Although such lubricants have been designed to be non-toxic as a food source contaminant, their lubricating properties are often less effective compared to conventional lubricants e.g., lubricants not having ingredients approved for direct food contact. The lubrication industry has, to some degree, overcome this problem by incorporating specialty additives into the lubricant compositions. For example, the inclusion of performance additives has been used to enhance antiwear properties, oxidation inhibition, rust/corrosion inhibition, metal passivation, extreme pressure, friction modification, foam inhibition, and lubricity. Such chemistries are described in the following patents: U.S. Pat. No. 5,538,654 (Lawate, et al.); U.S. Pat. No. 4,062,785 (Nibert); U.S. Pat. No. 4,828,727 (McAninch); U.S. Pat. No. 5,338,471 and U.S. Pat. No. 5,413,725 (Lai).

A drawback to the food-grade-lubricants described in the above patents relates to oxidation resistance, pour point characteristics, limited formulating capability for viscosity breadth, and limited viscosity protection. The lubricants often have poor rheology characteristics when subjected to prolonged heat and mechanical stress.

Therefore, there remains a need for a food-grade-lubricant that exhibits excellent hydrolytic stability, corrosion resistance, and anti-wear, with substantial improvements in oxidation resistance, pour point, viscosity index, viscosity breadth formulating capability, and viscosity stability when subjected to the thermal and mechanical stresses.

### SUMMARY OF THE PRESENT INVENTION

One aspect of the present invention is to extend the variety and compass of additives useful for improving the properties of food-grade-lubricants. The applicant has now discovered that when polyalphaolefins are formulated into food-grade-lubricant compositions, the compositions show enhanced oxidation resistance, pour point characteristics, and viscosities. The food-grade-lubricants are particularly useful as hydraulic oil, circulating oil, drip oil, general purpose oil, grease base oil, cable oil, chain oil, spindle oil, gear oil, and compressor oil for equipment in the food service industry.

Furthermore, the inventive compositions have been shown to have improved biodegradability, making them environmentally friendly. Surprisingly, some compositions can have a polyalphaolefin content greater than about 70% and pass biodegradability test method ASTM D-5864 Pw1.

Another aspect of the present invention relates to a food-grade-lubricant comprising: a) at least one vegetable oil selected from the group comprising natural vegetable oil, synthetic vegetable oil, genetically modified vegetable oil, and mixtures thereof; b) at least one polyalphaolefin; and c) at least one antioxidant; d) optionally, at least one food grade oil selected from the group comprising synthetic ester, white petroleum oil, hydrocracked petroleum oil, and mixtures thereof, wherein the composition ingredients have H-1 approval as required by the United States Department of Agriculture. It is understood that the H-1 designation will ultimately relate to a comparable classification in countries outside the United States in most cases.

In another aspect of the present invention, a method for the preparation of a food-grade-lubricant composition comprises the steps of 1) providing at least one vegetable oil selected from the group comprising natural vegetable oil, synthetic vegetable oil, genetically modified vegetable oil, and mixtures thereof; 2) providing at least one polyalphaolefin; and 3) providing at least one antioxidant; 4) optionally, providing at least one food grade oil selected from the group comprising synthetic ester, white petroleum oil, hydrocracked petroleum oil, and mixtures thereof; 5) blending 1), 2), 3), and 4) to form the composition.

Another aspect of the invention relates to a method of enhancing the lubrication of equipment used in the food service industry, comprising the steps of:

1) providing at least one food-grade-lubricant composition comprising:

a) at least one vegetable oil selected from the group comprising natural vegetable oil, synthetic vegetable oil, genetically modified vegetable oil, and mixtures thereof;

b) at least one polyalphaolefin; and

c) at least one antioxidant;

d) optionally, at least one food grade oil selected from the group comprising synthetic ester, white petroleum oil, hydrocracked petroleum oil, and mixtures thereof.

2) adding an effective amount of the composition into the equipment.

In accordance with one aspect of the present invention, a lubricant composition includes at least one triglyceride oil, at least one polyalphaolefin, and at least one antioxidant.

In accordance with one aspect of the present invention, the at least one triglyceride oil is selected from the group comprising: natural vegetable oil, synthetic vegetable oil, genetically modified vegetable oil, and mixtures thereof and the composition further includes at least one food grade oil selected from the group comprising: synthetic ester, white petroleum oil, hydrocracked petroleum oil, and mixtures thereof.

In accordance with one aspect of the present invention, the vegetable oil is selected from the group comprising: sunflower oil, canola oil, soybean oil, castor oil, high oleic sunflower, high oleic canola, high oleic soybean oil, and mixtures thereof.

In accordance with one aspect of the present invention, the vegetable oil is present in a range of from about 10% by weight to about 90% by weight. In other embodiments of the present invention the vegetable oil is greater than about 10% by weight, less than about 90% by weight, or any of the following percentages by weight: 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 86, 88, 89, and 90.

In accordance with one aspect of the present invention, the vegetable oil is present in a range of from about 30% by weight to about 70% by weight. In other embodiments of the present invention the vegetable oil is greater than about 30% by weight or less than about 70% by weight.

In accordance with one aspect of the present invention, the vegetable oil is present in a range of from about 40% by weight to about 60% by weight. In other embodiments of the present invention the vegetable oil is greater than about 40% by weight or less than about 60% by weight.

In accordance with one aspect of the present invention, the polyalphaolefin is selected from the group comprising: PAO2, PAO4, PAO6, PAO8, PAO9, PAO10, PAO40, PAO100, and mixtures thereof.

In accordance with one aspect of the present invention, the polyalphaolefin is present in a range of from about 10% by weight to about 90% by weight. In other embodiments of the present invention the polyalphaolefin is greater than about 10% by weight, less than about 90% by weight, or any of the following percentages by weight: 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 86, 88, 89, and 90.

In accordance with one aspect of the present invention, the polyalphaolefin is present in a range of from about 30% by weight to about 70% by weight. In other embodiments of the present invention the polyalphaolefin is greater than about 30% by weight or less than about 70% by weight.

In accordance with one aspect of the present invention, the polyalphaolefin is present in a range of from about 40% by weight to about 60% by weight. In other embodiments of the present invention the polyalphaolefin is greater than about 40% by weight or less than about 60% by weight.

In accordance with one aspect of the present invention, the antioxidant is selected from the group comprising: butyrated hydroxytoluene, phenl-a-naphthylamine, and mixtures thereof.

In accordance with one aspect of the present invention, the antioxidant is present in a range of from about 0.01% by weight to about 5.0% by weight. In other embodiments of the present invention the antioxidant is greater than about 0.01% by weight, less than about 5.0% by weight or any of the percentages by weight between 0.01 and 5.0, counting by hundredths (i.e. 0.01, 0.02, 0.03, 0.04, etc.)

In accordance with one aspect of the present invention, the antioxidant is present in a range of from about 0.25% by weight to about 1.5% by weight. In other embodiments of the present invention the antioxidant is greater than about 0.25% by weight or less than about 1.5% by weight.

In accordance with one aspect of the present invention, the antioxidant is present in a range of from about 0.5% by weight to about 1.0% by weight. In other embodiments of the present invention the antioxidant is greater than about 0.5% by weight or less than about 1.0% by weight.

In accordance with one aspect of the present invention, the composition has a rotating bomb oxidation test (RBOT) value greater than about 200 minutes.

In accordance with one aspect of the present invention, the composition further includes at least one additive chosen from the group comprising: antiwear inhibitors, rust/corrosion inhibitors, pour point depressants, viscosity improvers, tackifiers, metal deactivators, extreme pressure (EP) additives, friction modifiers, foam inhibitors, emulsifiers, and demulsifiers.

In accordance with one aspect of the present invention, the triglyceride oil has the formula

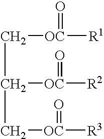

wherein R¹, R², and R³ are aliphatic hydrocarbyl groups that contain from about 7 to about 23 carbon atoms. In other embodiments of the present invention the aliphatic hydrocarbyl groups contain 7, 8, 9, 10, 11, 12, 13, 14, 15, 16, 17, 18, 19, 20, 21, 22, or 23 carbon atoms.

In accordance with one aspect of the present invention, the triglyceride has a monounsaturated character of at least 60 percent.

In accordance with one aspect of the present invention, the triglyceride has a monounsaturated character of at least 70 percent. In another embodiment of the present invention, the triglyceride has a monounsaturated character of between about 60 percent and about 70 percent.

In accordance with one aspect of the present invention, the triglyceride has a monounsaturated character of at least 80 percent. In another embodiment of the present invention, the triglyceride has a monounsaturated character of between about 60 percent and about 80 percent. In another embodiment of the present invention, the triglyceride has a monounsaturated character of between about 70 percent and about 80 percent.

In accordance with one aspect of the present invention, a method for preparing a food-grade-lubricant composition includes providing at least one triglyceride oil, providing at least one polyalpha olefin, providing at least one antioxidant, and blending the oil, olefin, and antioxidant to form the composition.

In accordance with one aspect of the present invention, the triglyceride oil is selected from the group comprising: natural vegetable oil, synthetic vegetable oil, genetically modified vegetable oil, and mixtures thereof and the method further includes providing at least one food grade oil selected from the group comprising: synthetic ester, white petroleum oil, a hydrocracked petroleum oil, and mixtures thereof.

In accordance with one aspect of the present invention, the vegetable oil is selected from the group comprising: sunflower oil, canola oil, soybean oil, castor oil, high oleic sunflower, high oleic canola, high oleic soybean oil, and mixtures thereof.

In accordance with one aspect of the present invention, the polyalphaolefin is selected from the group comprising: PAO2, PAO4, PAO6, PAO8, PAO9, PAO10, PAO40, PAO100, and mixtures thereof.

In accordance with one aspect of the present invention, the antioxidant is selected from the group comprising: butyrated hydroxytoluene, phenl-a-naphthylamine, and mixtures thereof.

In accordance with one aspect of the present invention, the vegetable oil is present in a range of from about 10% by weight to about 90% by weight.

In accordance with one aspect of the present invention, the polyalphaolefin is present in a range of from about 10% by weight to about 90% by weight.

In accordance with one aspect of the present invention, the antioxidant is present in a range of from about 0.01% by weight to about 5.0% by weight.

In accordance with one aspect of the present invention, the composition can be used as a hydraulic oil, circulating oil, drip oil, general purpose oil, grease base oil, cable oil, chain oil, spindle oil, gear oil, and compressor oil.

In accordance with one aspect of the present invention, a method for lubricating a food industry mechanical device, the method including lubricating the device with a composition comprising at least one vegetable oil selected from the group comprising natural vegetable oil, synthetic vegetable oil, genetically modified vegetable oil, and mixtures thereof, at least one polyalpha olefin, and at least one antioxidant.

In accordance with one aspect of the present invention, wherein the composition further comprises at least one food grade oil selected from the group comprising: synthetic ester, white petroleum oil, a hydrocracked petroleum oil, and mixtures thereof.

In accordance with one aspect of the present invention, the genetically modified oils have an oleic acid moiety:linoleic acid moiety ratio of from about 2 to about 90. In other embodiments of the present invention the ratio is greater than about 2, less than about 90, or any of the following: 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 86, 88, 89, and 90.

Other aspects, objects, features and advantages of the present invention would be apparent to one of ordinary skill in the art from the following detailed description illustrating the preferred embodiments of the invention.

### DETAILED DESCRIPTION OF THE INVENTION

The following glossary is provided as an aid to understand the use of certain terms herein. The definitions provided in the glossary are for illustrative purposes only, and are not intended to limit the scope of the invention.

(A) Triglyceride Oil

In practicing this invention, the base oil is a synthetic triglyceride or a natural oil of the formula

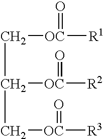

wherein R¹, R², and R³ are aliphatic hydrocarbyl groups that contain from about 7 to about 23 carbon atoms. The term “hydrocarbyl group” as used herein denotes a radical having a carbon atom directly attached to the remainder of the molecule. The aliphatic hydrocarbyl groups include the following:

(1) Aliphatic hydrocarbon groups; that is, alkyl groups such as heptyl, nonyl, undecyl, tridecyl, heptadecyl; alkenyl groups containing a single double bond such as heptenyl, nonenyl, undecenyl, tridecenyl, heptadecenyl, heneicosenyl; alkenyl groups containing 2 or 3 double bonds such as 8,11-heptadecadienyl and 8,11,14-heptadecatrienyl. All isomers of these are included, but straight chain groups are preferred.

(2) Substituted aliphatic hydrocarbon groups; that is groups containing non-hydrocarbon substituents which, in the context of this invention, do not alter the predominantly hydrocarbon character of the group. Those skilled in the art will be aware of suitable substituents. Examples are hydroxy, carbalkoxy, (especially lower carbalkoxy) and alkoxy (especially lower alkoxy), the term, “lower” denoting groups containing not more than 7 carbon atoms.

(3) Hetero groups, that is, groups which, while having predominantly aliphatic hydrocarbon character within the context of this invention, contain atoms other than carbon present in a chain or ring otherwise composed of aliphatic carbon atoms. Suitable hetero atoms will be apparent to those skilled in the art and include, for example, oxygen, nitrogen, and sulfur.

The triglyceride oils suitable for use in this invention are vegetable oils and modified vegetable oils. The vegetable oil triglycerides are naturally occurring oils. By “naturally occurring” it is meant that the seeds from which the oils are obtained have not been subjected to any genetic altering. Further, by “naturally occurring” it is meant that the oils obtained are not subjected to hydrogenation or any chemical treatment that alters the di- and tri-unsaturation character. The naturally occurring vegetable oils having utility in this invention comprise at least one of soybean oil, rapeseed oil, sunflower oil, coconut oil, lesquerella oil, canola oil, peanut oil, corn oil, cottonseed oil, palm oil, coconut oil, safflower oil, meadowfoam oil, or castor oil.

The triglyceride oils may also be modified vegetable oils. Triglyceride oils are modified either chemically or genetically. Hydrogenation of naturally occurring triglycerides is the primary means of chemical modification. Naturally occurring triglyceride oils have varying fatty acid profiles. The fatty acid profile for naturally occurring sunflower oil is

| | |
|---|---|
| palmitic acid | 70 percent |
| stearic acid | 4.5 percent |
| oleic acid | 18.7 percent |
| linoleic acid | 67.5 percent |
| linolenic acid | 0.8 percent |
| other acids | 1.5 percent |

By chemically modifying sunflower oil by hydrogenation, it is meant that hydrogen is permitted to react with the unsaturated fatty acid profile present such as oleic acid, linoleic acid, and linolenic acid. The object is not to remove all the unsaturation. Further, the object is not to hydrogenate such that the oleic acid profile is reduced to a stearic acid profile. The object of chemical modification via hydrogenation is to engage the linoleic acid profile and reduce or convert a substantial portion of it to an oleic acid profile. The linoleic acid profile of naturally occurring sunflower oil is 67.5 percent. It is a goal of chemical modification to hydrogenate such that the linoleic acid is reduced to about 25 percent. That means that the oleic acid profile is increased from 18.7 percent to about 61 percent (18.7 percent original oleic acid profile plus 42.5 percent generated oleic acid from linoleic acid).

Hydrogenation is the reaction of a vegetable oil with hydrogen gas in the presence of a catalyst. The most commonly used catalyst is a nickel catalyst. This treatment results in the addition of hydrogen to the oil, thus reducing the linoleic acid profile and linolenic acid profile. Only the unsaturated fatty acid profiles participate in the hydrogenation reaction. During hydrogenation, other reactions also occur, such as shifting of the double bonds to a new position and also twisting from the cis form to the higher melting trans form.

Table I shows the oleic acid (18:1), linoleic acid (18:2) and linolenic acid (18:3) profiles of selected naturally occurring vegetable oils. It is possible to chemically modify, via hydrogenation, a substantial portion of the linoleic acid profile of the triglyceride to increase the oleic acid profile to above 60 percent.

TABLE I

| Oil | 18:1 | 18:2 | 18:3 |
|---|---|---|---|
| Corn oil | 25.4 | 59.6 | 1.2 |
| Cottonseed oil | 18.6 | 54.4 | 0.7 |
| Peanut oil | 46.7 | 32.0 | — |
| Safflower oil | 12.0 | 77.7 | 0.4 |
| Soybean oil | 23.2 | 53.7 | 7.6 |
| Sunflower oil | 18.7 | 67.5 | 0.8 |

Genetic modification occurs in the seed stock. The harvested crop then contains a triglyceride oil that when extracted has a much higher oleic acid profile and a much lower linoleic acid profile. Referring to Table I above, a naturally occurring sunflower oil has an oleic acid profile of 18.7 percent. A genetically modified sunflower oil has an oleic acid profile of 81.3 percent and linoleic acid profile of 9.0 percent. One can also genetically modify the various vegetable oils from Table I to obtain an oleic acid profile of above 90 percent. The chemically modified vegetable oils comprise at least one of a chemically modified corn oil, chemically modified cottonseed oil, chemically modified peanut oil, chemically modified palm oil, chemically modified coconut oil, chemically modified castor oil, chemically modified canola oil, chemically modified rapeseed oil, chemically modified safflower oil, chemically modified soybean oil, and chemically modified sunflower oil.

In a preferred embodiment, the aliphatic hydrocarbyl groups of R¹, R², and R³ are such that the triglyceride has a monounsaturated character of at least 60 percent, preferably at least 70 percent, and most preferably at least 80 percent. Triglycerides having utility in this invention are exemplified by vegetable oils that are genetically modified such that they contain a higher than normal oleic acid content. Normal sunflower oil has an oleic acid content of 25-30 percent. By genetically modifying the seeds of sunflowers, a sunflower oil can be obtained wherein the oleic content is from about 60 percent up to about 90 percent. That is, the R¹, R², and R³ groups are heptadecenyl groups and the R¹COO—, R²COO—, and R³COO— to the 1,2,3-propanetriyl group CH₂CHCH₂ are the residue of an oleic acid molecule. U.S. Pat. No. 4,627,192 and U.S. Pat. No. 4,743,402 are herein incorporated by reference for their disclosure of the preparation of high oleic sunflower oil.

For example, a triglyceride comprised exclusively of an oleic acid moiety has an oleic acid content of 100% and consequently a monounsaturated content of 100%. Where the triglyceride is made up of acid moieties that are 70% oleic acid, 10% stearic acid, 13% palmitic acid, and 7% linoleic acid, the monounsaturated content is 70%. The preferred triglyceride oils are high oleic acid, that is, genetically modified vegetable oils (at least 60 percent) triglyceride oils. Typical high oleic vegetable oils employed within the present invention are high oleic safflower oil, high oleic canola oil, high oleic peanut oil, high oleic corn oil, high oleic rapeseed oil, high oleic sunflower oil, high oleic cottonseed, high oleic lesquerella oil, high oleic palm oil, high oleic castor oil, high oleic meadowfoam oil, and high oleic soybean oil. Canola oil is a variety of rapeseed oil containing less than 1 percent erucic acid. A preferred high oleic vegetable oil is high oleic sunflower oil obtained from Helianthus sp. This product is available from AC Humko, Cordova, Tenn., 38018 as TriSun™ high oleic sunflower oil. TriSun 80 is a high oleic triglyceride wherein the acid moieties comprise 80 percent oleic acid. TriSun 90 is a high oleic triglyceride wherein the acid moieties comprise 90 percent oleic acid. Another preferred high oleic vegetable oil is high oleic canola oil obtained from Brassica campestris or Brassica napus, also available from AC Humko as RS high oleic oil. RS80 oil signifies a canola oil wherein the acid moieties comprise 80 percent oleic acid.

It is further to be noted that genetically modified vegetable oils have high oleic acid contents at the expense of the di- and tri-unsaturated acids. A normal sunflower oil has from 20-40 percent oleic acid moieties and from 50-70 percent linoleic acid moieties. This gives a 90 percent content of mono- and di-unsaturated acid moieties (20+70) or (40+50). Genetically modifying vegetable oils generate a low di- or tri- unsaturated moiety vegetable oil. The genetically modified oils of this invention have an oleic acid moiety:linoleic acid moiety ratio of from about 2 up to about 90. A 60 percent oleic acid moiety content and 30 percent linoleic acid moiety content of a triglyceride oil gives a ratio of 2. A triglyceride oil made up of an 80 percent oleic acid moiety and 10 percent linoleic acid moiety gives a ratio of 8. A triglyceride oil made up of a 90 percent oleic acid moiety and 1 percent linoleic acid moiety gives a ratio of 90. The ratio for normal sunflower oil is 0.5 (30 percent oleic acid moiety and 60 percent linoleic acid moiety).

The vegetable oil is present in the composition in a range of from about 10% to about 90%. Preferably from about 30% to about 70%. Most preferably from about 40% to about 60%. A vegetable content greater than 90% is less desirable in that there is a reduction in oxidation and pour point stability.

The term “greases” described herein is a semi-liquid to solid dispersion of a thickening agent in a liquid (base oil). It consists of a mixture of approximately 70% to 90% base oils and additives (described within this invention); the remainder is thickener. The most common thickeners include: a list of metal soaps including calcium, sodium, lithium, aluminum (with the ability to be complexed for higher temperatures), a number of inorganic substances e.g. bentonite and silica gel, and synthetic thickeners like polyurea.

The food-grade-lubricant composition of the present invention comprises at least one polyalphaolefin. Polyalphaolefins are made by combining two or more decene molecules into an oligomer, or short-chain-length polymer. PAOs are all-hydrocarbon structures, and they contain no sulfur, phosphorus, or metals. Because they are wax-free, they have low pour points, usually below −40° C. Viscosity grades range from 2 to 100 cSt, and viscosity indexes for all but the lowest grades exceed 140. PAOs have good thermal stability, but they require suitable antioxidant additives to resist oxidation. It is common to the industry that PAOs have limited ability to dissolve some additives and tend to shrink seals. It has been found in this invention, that both problems are overcome by formulating with vegetable oils. All of the different viscosity grade PAOs mentioned above are included in this invention and are sanctioned by the FDA under 21 CFR 178.3570 USDA H-1, Lubricants with Incidental Food Contact (not to exceed 10 ppm extraction into food). Under these sanctions, blending edible vegetable base oil into the formula will limit the use of the PAOs, providing a safer product through dilution. Other useful polyalphaolefins are described in U.S. Pat. No. 6,534,454 incorporated herein by reference. The polyalphaolefin is present in the composition in a range of from about 10% to about 90%. Preferably from about 30% to about 70%. Most preferably from about 40% to about 60%. A polyalphaolefin content greater than 90% is less desirable in that there is a reduction in biodegradability and compatibility.

Antioxidant

The food-grade-lubricant composition of the present invention comprises at least one antioxidant. Suitable examples that are food grade FDA approved include butyrated hydroxytoluene (BHT), phenl-a-naphthylamine (PANA), octylated/butylated diphenylamine, high molecular weight phenolic antioxidants, hindered bis-phenolic antioxidant, di-alpha-tocopherol, di-tertiary butyl phenyl. The most preferred antioxidants are PANA and BHT. Other useful antioxidants are described in U.S. Pat. No. 6,534,454 incorporated herein by reference. The antioxidant is present in the composition in a range of from about 0.01% to about 5.0%. Preferably from about 0.25% to about 1.5%. Most preferably from about 0.5% to about 1.0%.

Furthermore, the compositions may also include any of the ingredients/additives commonly used in food grade lubricants including antiwear inhibitors, rust/corrosion inhibitors, pour point depressants, viscosity improvers, tackifiers, metal deactivators, extreme pressure (EP) additives, friction modifiers, foam inhibitors, emulsifiers, and demulsifiers.

The preferred additives in this invention include:

The Anti-wear Inhibitor, Extreme Pressure Additive and Friction Modifier

To prevent wear on the metal surface, the present invention utilizes an anti-wear inhibitor/EP additive and friction modifier. Anti-wear inhibitors, EP additives, and fiction modifiers are available off the shelf from a variety of vendors and manufacturers. Some of these additives can perform more than one task and any may be utilized in the present invention, as long as they are food grade. One food grade product that can provide anti-wear, EP, reduced friction and corrosion inhibition is phosphorous amine salt of the formula:

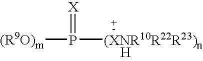

wherein R⁹ and R¹⁰ are independently aliphatic groups containing from about 1 up to about 24 carbon atoms, R²² and R²³ are independently hydrogen or aliphatic groups containing from about 1 up to about 18 aliphatic carbon atoms, the sum of m and n is 3 and X is oxygen or sulfur. In one embodiment, R⁹ contains from about 8 up to 18 carbon atoms, R¹⁰ is

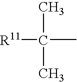

wherein R¹¹ is an aliphatic group containing from about 6 up to about 12 carbon atoms, R²² and R²³ are hydrogen, m is 2, n is 1 and X is oxygen. An example of one such phosphorous amine salt is Irgalube® 349, which is commercially available from Ciba-Geigy.

Another food grade anti-wear/EP inhibitor/friction modifier is a phosphorous compound of the formula:

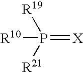

wherein R¹⁹, R²⁰, and R²¹ are independently hydrogen, an aliphatic or alkoxy group containing from about 1 up to about 12 carbon atoms, or an aryl or aryloxy group wherein the aryl group is phenyl or naphthyl and the aryloxy group is phenoxy or naphthoxy and X is oxygen or sulfur. An example of one such phosphorus compound is triphenyl phosphothionate (TPPT), which is commercially available from Ciba-Geigy under the trade name Irgalube® TPPT.

The anti-wear inhibitors, EP, and friction modifiers are typically about 0.1 to about 4 weight percent of the lubricant composition and may be used separately or in combination.

The Corrosion Inhibitor

To prevent corrosion of the metal surfaces, the present invention utilizes a corrosion inhibitor. Corrosion inhibitors are available off the shelf from a variety of vendors and manufacturers. Any corrosion inhibitor may be utilized in the present invention that is food grade, as long as chosen using sound chemical judgment.

The corrosion inhibitor is typically about 0.01 to about 4 weight percent of the lubricant composition.

In one embodiment, the corrosion inhibitor is comprised of a corrosion additive and a metal deactivator. The corrosion inhibitor and the metal deactivator are food grade and comply with FDA regulations. One additive is the N-acyl derivative of sarcosine, which has the formula:

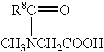

wherein R⁸ is an aliphatic group containing from 1 up to about 24 carbon atoms. Preferably R⁸ contains from 6 to 24 carbon atoms and most preferably from 12 to 18 carbon atoms. An example of an additive of N-acyl derivative of sarcosine is N-methyl-N-(1-oxo-9-octadecenyl) glycine wherein R⁸ is a heptadecenyl group. This derivative is available from Ciba-Geigy under the trade name Sarkosyl® O.

Another additive is imidazoline of the formula:

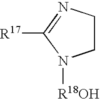

wherein R¹⁷ is an aliphatic group containing from 1 up to about 24 carbon atoms and R¹⁸ is an alkylene group containing from 1 up to about 24 carbon atoms. Preferably R¹⁷ is an alkenyl group containing from 12 to 18 carbon atoms. Preferably R¹⁸ contains from 1 to 4 carbon atoms and most preferably R¹⁸ is an ethylene group. An example of one such imadazoline has the formula:

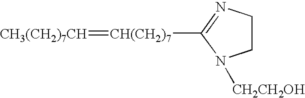

and is commercially available from Ciba-Geigy under the trade name Amine O.

Typically, the corrosion additive is about 0.01 to about 4 weight percent of the lubricant composition. If the additive is the N-acyl derivative of sarcosine, then it is preferably about 0.1 to about 1 weight percent of the lubricant composition. If the additive is imidazoline, then it is preferably about 0.05 to about 2 weight percent of the lubricant composition. The lubricant can include more than one corrosion additive. For example, the lubricant can include both the N-acyl derivative of sarcosine and imidazoline.

The Metal Deactivator

One metal deactivator is triazole or substituted triazole. For example, toly-triazole or tolu-triazole may be utilized in the present invention. However, a preferred triazole, is tolu-triazole sold commercially by Ciba-Geigy under the trade name Irgamet 39, which is a food grade triazole.

Typically, the metal deactivator is about 0.05 to about 0.3 weight percent of the lubricant composition. If the metal activator is Irgamet 39, then it is preferably about 0.05 to about 0.2 weight percent of the lubricant composition.

Viscosity Modifier, Thickener and Tackifier

Optionally, the lubricant may further include an additive from the group comprising: Viscosity modifiers-including, but not limited to, ethylene vinyl acetate, polybutenes, polyisobutylenes, polymethacrylates, olefin copolymers, esters of styrene maleic anhydride copolymers, hydrogenated styrene-diene copolymers, hydrogenated radial polyisoprene, alkylated polystyrene, fumed silicas, complex esters, and food grade tackifiers like natural rubber solubilized in food grade oils.

The addition of a food grade viscosity modifier, thickener, and/or tackifier provides adhesiveness and improves the viscosity and viscosity index of the lubricant. Some applications and environmental conditions may require an additional tacky surface film that protects equipment from corrosion and wear. In this embodiment, the viscosity modifier, thickener/tackifier is about 1 to about 20 weight percent of the lubricant. However, the viscosity modifier, thickener/tackifier can be from about 0.5 to about 30 weight percent. An example of a food grade material that can be used in this invention is Functional V-584 a Natural Rubber viscosity modifier/tackifier, which is available from Functional Products, Inc., Macedonia, Ohio. Another example is a complex ester CG 5000 that is also a multifunctional product, viscosity modifier, pour point depressant, and friction modifier from Inolex Chemical Co. Philadelphia, Pa.

Other Oils

Other food grade oils may be added to the composition in the range of about 0.1 to about 30% by weight. These food grade oils could include white petroleum oils, synthetic esters (as described in patent U.S. Pat. No. 6,534,454), hydrocracked petroleum oil (known in the industry as “Group II or III petroleum oils”).

The lubricants described in the present invention show improved biodegradability. Surprisingly, some compositions having a polyalphaolefin content greater than about 70% pass biodegradability test method ASTM D-5864 Pwl.

Although the composition of the present invention is particularly useful as a lubricant in the food service industry, it is not limited to applications that require direct food contact. For example, the unique combination of properties allows the inventive lubricant to be used in any application wherein a continuous and efficient reduction in friction is required. Examples may include engine oil, hydraulic fluid, grease, etc.

The food-grade-lubricant compositions can be formed using a method comprising the steps of:

A) providing at least one vegetable oil selected from the group comprising natural vegetable oil, synthetic vegetable oil, genetically modified vegetable oil, and mixtures thereof;

B) providing at least one polyalpha olefin; and

C) providing at least one antioxidant;

D) optionally, providing at least one food grade oil selected from the group comprising synthetic ester, white petroleum oil, hydrocracked petroleum oil, and mixtures thereof.

E) blending A), B), C), and D) to form the composition.

The food-grade-lubricant compositions described above can be used in all types of food processing equipment.

The food-grade-lubricant compositions of the invention exhibit markedly enhanced characteristics compared to similar lubricants used in the food service industry.

All of the cited patents and publications are incorporated herein by reference. The following specific examples are provided to better assist the reader in the various aspects of practicing the present invention. As these specific examples are merely illustrative, nothing in the following descriptions should be construed as limiting the invention in any way.

Test Methods

The following test methods were used to characterize the food-grade-lubricant compositions of the present invention:

| | | |
|---|---|---|
| Viscosity @40° C. | ASTM D-445 | 31.92 cSt |
| Viscosity @100° C. | ASTM D-445 | 7.0 cSt |
| Viscosity index | ASTM D-2270 | 193 |
| 4-ball wear | ASTM D-4172 | .34 mm |
| | | .08 coefficient of friction |
| Rust | ASTM D-665 | |
| A-Distilled Water | | Pass-Clean |
| B-Synthetic Sea Water | | Pass-Clean |
| Oxidation | ASTM D-2272 | 244 min. |
| Copper corrosion | ASTM D-130 | 1B |
| Demulsification | ASTM D-1401 | 40-40-0 (10 min) |
| Pour point | ASTM D-97 | −21° C. |
| Biodegradability | ASTM D-5864 | Ultimate PW1 Average 68% |

### EXAMPLES

| | |
|---|---|
| Component | % Weight |

Formula 1: Bio-Food Grade AW ISO 46
HYDRAULIC OIL

| | |
|---|---|
| HO (high oleic) Canola | 49.3 |
| PAO 8 | 47.0 |
| Sarkosyl 0 | .1 |
| Irgalube 349 | .5 |
| Irgamet 39 | .1 |
| PAO 40 | 2.0 |
| PANA | .5 |
| BHT | .5 |
| Viscosity @40° C. | 41.82 |
| Viscosity Index | 176 |
| Viscosity @ 100° C. | 8.23 |

Formula 2: Bio-Food Grade R&O ISO 68
CIRCULATING OIL

| | |
|---|---|
| HO Canola | 73.3 |
| PAO 40 | 25.5 |
| PANA | .5 |
| BHT | .5 |
| Sarkosyl 0 | .1 |
| Irgamet 39 | .1 |
| Viscosity @40° C. | 65.19 |
| Viscosity @100° C. | 12.70 |
| Viscosity Index | 198 |

Formula 3: Bio-Food Grade AW ISO 32
HYDRAULIC FLUID

| | |
|---|---|
| HO Sun | 50.5 |
| Indopl H1500 | 2.8 |
| Sarkosyl 0 | .1 |
| PANA | .5 |
| BHT | .5 |
| PAO 4 | 45.0 |
| Irgalube 349 | .5 |
| Irgamet 39 | .1 |
| Viscosity @40° C. | 32.09 |
| Viscosity @100° C. | 6.99 |
| Viscosity Index | 188 |

Formula 4: Bio-Food Grade AW ISO 22
HYDRAULIC FLUID

| | |
|---|---|
| HO Canola | 38.3 |
| PAO 4 | 60.0 |
| Sarkosyl 0 | .1 |
| PANA | .5 |
| BHT | .5 |
| Irgalube 349 | .5 |
| Irgamet 39 | .1 |
| Viscosity @40° C. | 22.52 |
| Viscosity @100° C. | 5.29 |
| Viscosity Index | 181 |

Formula 5: Bio-Food Grade AW ISO 10
SPINDLE OIL

| | |
|---|---|
| HO Canola | 34.3 |
| PAO 2 | 64.0 |
| Sarkosyl 0 | .1 |
| PANA | .5 |
| BHT | .5 |
| Irgalube 349 | .5 |
| Irgamet 39 | .1 |
| Viscosity @40° C. | 10.13 |
| Viscosity @100° C. | 3.01 |
| Viscosity Index | 167 |

Formula 6: Bio-Food Grade AW ISO 100
HYDRAULIC FLUID

| | |
|---|---|
| HO Canola | 56.80 |
| PAO 4O | 41.50 |
| Sarkosyl 0 | .1 |
| PANA | .5 |
| BHT | .5 |
| Irgamet 39 | .1 |
| Irgalube 349 | .5 |
| Viscosity @40° C. | 99.97 |
| Viscosity @100° C. | 16.44 |
| Viscosity Index | 178 |

Formula 7: Bio-Food Grade EP ISO 220
GEAR OIL

| | |
|---|---|
| HO Sun | 49.90 |
| PAO 100 | 47.90 |
| Sarkosyl 0 | .1 |
| PANA | .5 |
| Irgamet 39 | .1 |
| Irgalube 349 | 1.0 |
| BHT | .5 |
| Viscosity @40° C. | 206.18 |
| Viscosity @100° C. | 28.63 |
| Viscosity Index | 178 |

Formula 8: Bio-Food Grade EP ISO 320
GEAR OIL

| | |
|---|---|
| HO Sun | 45.90 |
| PAO 100 | 31.90 |
| Sarkosyl 0 | .1 |
| CG 5000 | 20.0 |
| Irgamet 39 | .1 |
| Irgalube 349 | 1.0 |
| PANA | .5 |
| BHT | .5 |
| Viscosity @40° C. | 312.31 |
| Viscosity @100° C. | 43.39 |
| Viscosity Index | 197 |

Formula 9: Bio-Food Grade EP ISO 460
GEAR OIL

| | |
|---|---|
| HO Sun | 40.30 |
| PAO 100 | 35.50 |
| Func V422 | 2.0 |
| CG 5000 | 20.0 |
| Irgamet 39 | .1 |
| Irgalube 349 | 1.0 |
| Sarkosyl 0 | .1 |
| PANA | .5 |
| BHT | .5 |
| Viscosity @40° C. | 422.23 |
| Viscosity @100° C. | 54.56 |
| Viscosity Index | 197 |

The above formulas are intended to be examples of embodiments of the invention, and are not intended to limit the invention in any manner. For example, in Formula 3, the HO Sun could be decreased, the amount of PAO 4 could be increased up to approximately 60%, and the amount of Indopl H1500 (a polyisobutene) could be increased. In Formula 5, PAO 2 could be increased to approximately 70%, with the HO Canola being decreased accordingly.

The following is an example of the process of formulating one embodiment of this invention. 227.25 g (50.5% weight) of Trisun 90 (viscosity of 39.70 cSt) is mixed with 202.50 g (45% weight) of PAO 4 (viscosity of 16.90 cSt) at 130° F. The mixture of Trisun 90 and PAO 4 is then mixed with 12.60 g (2.80% weight) of Indopl H1500 (viscosity of 100000.00 cSt) at 135° F. The mixture of Trisun 90, PAO 4, and Indopl H1500 is then mixed with 2.25 g (0.50% weight) of Irgalube 349 (viscosity of 1.10 cSt), 0.45 g (0.10% weight) of Sarkosyl O, and 0.45 g (0.10% weight) of Irgamet 39 at 130° F. Then 2.25 g (0.50% weight) of BHT (viscosity of 1.10 cSt) is mixed with 2.25 g (0.50% weight) of PANA (viscosity of 1.10 cSt) at 160° F., and then the mixture of BHT and PANA is mixed with the mixture of Trisun 90, PAO 4, Indopl H1500, Irgalube 349, Sarkosyl O, and Irgamet 39 at 140° F. This formula has a viscosity at 40° C. of 31.92 cSt, a viscosity at 100° C. of 7.0 cSt, and a viscosity index of 193.

Another example is as follows: 1691.7 g (50.5% weight) of Trisun 90 (viscosity of 39.70 cSt) is mixed with 1507.51 g (45% weight) of PAO 4 (viscosity of 16.90 cSt) at 130° F. The mixture of Trisun 90 and PAO 4 is then mixed with 93.80 g (2.80% weight) of Indopl H1500 (viscosity of 100000.00 cSt) at 135° F. The mixture of Trisun 90, PAO 4, and Indopl H1500 is then mixed with 16.75 g (0.50% weight) of Irgalube 349 (viscosity of 1.10 cSt), 3.35 g (0.10% weight) of Sarkosyl O, and 3.35 g (0.10% weight) of Irgamet 39 at 130° F. Then 16.75 g (0.50% weight) of BHT (viscosity of 1.10 cSt) is mixed with 16.75 g (0.50% weight) of PANA (viscosity of 1.10 cSt) at 160° F., and then the mixture of BHT and PANA is mixed with the mixture of Trisun 90, PAO 4, Indopl H1500, Irgalube 349, Sarkosyl O, and Irgamet 39 at 140° F. This formula has a viscosity at 40° C. of 31.60 cSt. The above test results show improved results over the prior compositions.

Other than in the operating examples, or where otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contain certain errors necessarily resulting from the standard deviation found in their respective testing measurements.

The above examples have been depicted solely for the purpose of exemplification and are not intended to restrict the scope or embodiments of the invention. The invention is further illustrated with reference to the claims that follow thereto.

1. A lubricant composition comprising:
a) at least one triglyceride oil;
b) at least one polyalphaolefin; and,
c) at least one antioxidant.

2. The composition of claim 1, wherein the at least one triglyceride oil is selected from the group comprising: natural vegetable oil, synthetic vegetable oil, genetically modified vegetable oil, and mixtures thereof and the composition further comprises:
at least one food grade oil selected from the group comprising: synthetic ester, white petroleum oil, hydrocracked petroleum oil, and mixtures thereof.

3. The composition of claim 2, wherein the vegetable oil is selected from the group comprising: sunflower oil, canola oil, soybean oil, castor oil, high oleic sunflower, high oleic canola, high oleic soybean oil, and mixtures thereof.

4. The composition of claim 2, wherein the vegetable oil is present in a range of from about 10% by weight to about 90% by weight.

5. The composition of claim 4, wherein the vegetable oil is present in a range of from about 30% by weight to about 70% by weight.

6. The composition of claim 5, wherein the vegetable oil is present in a range of from about 40% by weight to about 60% by weight.

7. The composition of claim 1, wherein the polyalphaolefin is selected from the group comprising: PAO2, PAO4, PAO6, PAO8, PAO9, PAO10, PAO40, PAO10, and mixtures thereof.

8. The composition in claim 1, wherein the polyalphaolefin is present in a range of from about 10% by weight to about 90% by weight.

9. The composition in claim 8, wherein the polyalphaolefin is present in a range of from about 30% by weight to about 70% by weight.

10. The composition in claim 9, wherein the polyalphaolefin is present in a range of from about 40% by weight to about 60% by weight.

11. The composition in claim 1, wherein the antioxidant is selected from the group comprising: butyrated hydroxytoluene, phenl-a-naphthylamine, and mixtures thereof.

12. The composition in claim 1, wherein the antioxidant is present in a range of from about 0.01% by weight to about 5.0% by weight.

13. The composition in claim 12, wherein the antioxidant is present in a range of from about 0.25% by weight to about 1.5% by weight.

14. The composition in claim 13, wherein the antioxidant is present in a range of from about 0.5% by weight to about 1.0% by weight.

15. The composition in claim 1, having a RBOT value greater than 200 minutes.

16. The composition of claim 2, wherein the composition further comprises at least one additive chosen from the group comprising: antiwear inhibitors, rust/corrosion inhibitors, pour point depressants, viscosity improvers, tackifiers, metal deactivators, extreme pressure (EP) additives, friction modifiers, foam inhibitors, emulsifiers, and demulsifiers.

17. The composition of claim 2, wherein the genetically modified oils have an oleic acid moiety:linoleic acid moiety ratio of from about 2 to about 90.

18. The composition of claim 1, wherein the triglyceride oil has the formula 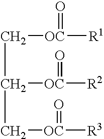
wherein R¹, R², and R³ are aliphatic hydrocarbyl groups that contain from about 7 to about 23 carbon atoms.

19. The composition of claim 18, wherein the triglyceride has a monounsaturated character of at least 60 percent.

20. The composition of claim 19, wherein the triglyceride has a monounsaturated character of at least 70 percent.

21. The composition of claim 20, wherein the triglyceride has a monounsaturated character of at least 80 percent.

22. A method for preparing a food-grade-lubricant composition comprising the steps of:
a) providing at least one triglyceride oil;
b) providing at least one polyalpha olefin;
c) providing at least one antioxidant; and,
d) blending the oil, olefin, and antioxidant to form the composition.

23. The method of claim 22, wherein the triglyceride oil is selected from the group comprising: natural vegetable oil, synthetic vegetable oil, genetically modified vegetable oil, and mixtures thereof and the method further comprises the step of:
e) providing at least one food grade oil selected from the group comprising: synthetic ester, white petroleum oil, a hydrocracked petroleum oil, and mixtures thereof.

24. The method as described in claim 23, wherein the vegetable oil is selected from the group comprising: sunflower oil, canola oil, soybean oil, castor oil, high oleic sunflower, high oleic canola, high oleic soybean oil, and mixtures thereof.

25. The method as described in claim 22, wherein the polyalphaolefin is selected from the group comprising: PAO2, PAO4, PAO6, PAO8, PAO9, PAO10, PAO40, PAO100, and mixtures thereof.

26. The method as described in claim 22, wherein the antioxidant is selected from the group comprising: butyrated hydroxytoluene, phenl-a-naphthylamine, and mixtures thereof.

27. The method as described in claim 22, wherein the vegetable oil is present in a range of from about 10% by weight to about 90% by weight.

28. The method as described in claim 22, wherein the polyalphaolefin is present in a range of from about 10% by weight to about 90% by weight.

29. The method as described in claim 22, wherein the antioxidant is present in a range of from about 0.01% by weight to about 5.0% by weight.

30. The composition in claim 22, wherein the composition can be used as a hydraulic oil, circulating oil, drip oil, general purpose oil, grease base oil, cable oil, chain oil, spindle oil, gear oil, and compressor oil.

31. A method for lubricating a food industry mechanical device, the method comprising the steps of:
lubricating the device with a composition comprising:
at least one vegetable oil selected from the group comprising natural vegetable oil, synthetic vegetable oil, genetically modified vegetable oil, and mixtures thereof;
at least one polyalpha olefin; and,
at least one antioxidant.

32. The method of claim 31, wherein the composition further comprises at least one food grade oil selected from the group comprising: synthetic ester, white petroleum oil, a hydrocracked petroleum oil, and mixtures thereof.
